(19) United States
(12) Patent Application Publication
(10) Pub. No.: US 2019/0056810 A1
(43) Pub. Date: Feb. 21, 2019

(54) Method of Handling Sensing Data and Related Image Sensing Circuit

(71) Applicant: NOVATEK Microelectronics Corp., Hsin-Chu (TW)

(72) Inventors: Yueh-Teng Mai, Hsinchu City (TW); Shao-Yang Chiang, Hsinchu City (TW); Chun-Yen Lin, Hsinchu County (TW)

(21) Appl. No.: 15/679,166

(22) Filed: Aug. 17, 2017

(51) Int. Cl. G06F 3/0354; G06K 9/00

(52) U.S. Cl. CPC G06F 3/03547; G06K 9/00087; G06K 9/0008; G06K 9/0002

(57) ABSTRACT

A method of handling a plurality of sensing data includes generating a threshold code for the plurality of sensing data; comparing each of the plurality of sensing data with the threshold code to determine whether a data code of each of the plurality of sensing data is a valid data code or an invalid data code; filtering out at least one first sensing data which has the invalid data code among the plurality of sensing data; and generating a final data by averaging at least one second sensing data which has the valid data code among the plurality of sensing data.

### BACKGROUND OF THE INVENTION

### 1. Field of the Invention

The present invention is related to a method of handling image sensing data and a related image sensing circuit, and more particularly, to a method of handling image sensing data and a related image sensing circuit for fingerprint sensing.

### 2. Description of the Prior Art

Fingerprint sensing technology is widely applied in a variety of electronic products such as a mobile phone, laptop, tablet, personal digital assistant (PDA), and portable electronics, for realizing identity recognition. The fingerprint sensing allows a user to perform identity recognition conveniently, where the user only needs to put his/her finger on a fingerprint sensor to login the electronic device instead of entering long and tedious username and password.

The fingerprint sensing may be performed via a capacitive image sensor or a light sensor, both of which are easily affected by noise interference, especially the interference from power noise. However, most power adapters in the market fail to provide satisfactory noise channelization performance. When the electronic device is charged and connected to a power adapter, the power noise may reduce the quality of the sensed fingerprint image. In a practical test on the fingerprint sensing function of an electronic product connected to a poor power adapter, it appears that the power noise generates a severe degradation on the sensing image, which may approach to a white image or a black image. Thus, the industry is working on enhancing noise immunity for the fingerprint sensing system.

### SUMMARY OF THE INVENTION

It is therefore an objective of the present invention to provide a method of handling image sensing data and a related image sensing circuit for fingerprint sensing.

An embodiment of the present invention discloses a method of handling a plurality of sensing data. The method comprises generating a threshold code for the plurality of sensing data; comparing each of the plurality of sensing data with the threshold code to determine whether a data code of each of the plurality of sensing data is a valid data code or an invalid data code; filtering out at least one first sensing data which has the invalid data code among the plurality of sensing data; and generating a final data by averaging at least one second sensing data which has the valid data code among the plurality of sensing data.

An embodiment of the present invention further discloses an image sensing circuit, which comprises a receiver and a processor. The receiver is configured for generating a plurality of sensing data according to a plurality of sensing signals from an image sensor. The processor, coupled to the receiver, is configured for performing the following steps: generating a threshold code for the plurality of sensing data; comparing each of the plurality of sensing data with the threshold code to determine whether a data code of each of the plurality of sensing data is a valid data code or an invalid data code; filtering out at least one first sensing data which has the invalid data code among the plurality of sensing data; and generating a final data by averaging at least one second sensing data which has the valid data code among the plurality of sensing data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of averaging a plurality of sensing data to reduce or eliminate the error of image data.

FIG. 2 is a schematic diagram of an image sensing system according to an embodiment of the present invention.

FIG. 3 is a flow chart of a process according to an embodiment of the present invention.

FIG. 4A is a schematic diagram of determining the validity of data codes according to an embodiment of the present invention.

FIG. 4B is a schematic diagram of determining the validity of data codes according to another embodiment of the present invention.

FIG. 5 is a schematic diagram of averaging sensing data after filtering out invalid data codes.

FIG. 6 is a schematic diagram of comparison of different fingerprint images obtained by different methods.

### DETAILED DESCRIPTION

In order to enhance the quality of the fingerprint image generated from an image sensor, the image sensing result may be generated by averaging the values of multiple sensing data obtained in several consecutive scan cycles. In a scan cycle, each sensing pixel of the image sensor may generate a sensing signal, which is then converted to a sensing data via an analog to digital converter (ADC). The sensing data may be deviated upward or downward from its accurate value due to noise interference. By averaging the values of multiple sensing data in different scan cycles, the errors in the sensing data (including the upward or downward deviation) may be reduced or eliminated after the average operation.

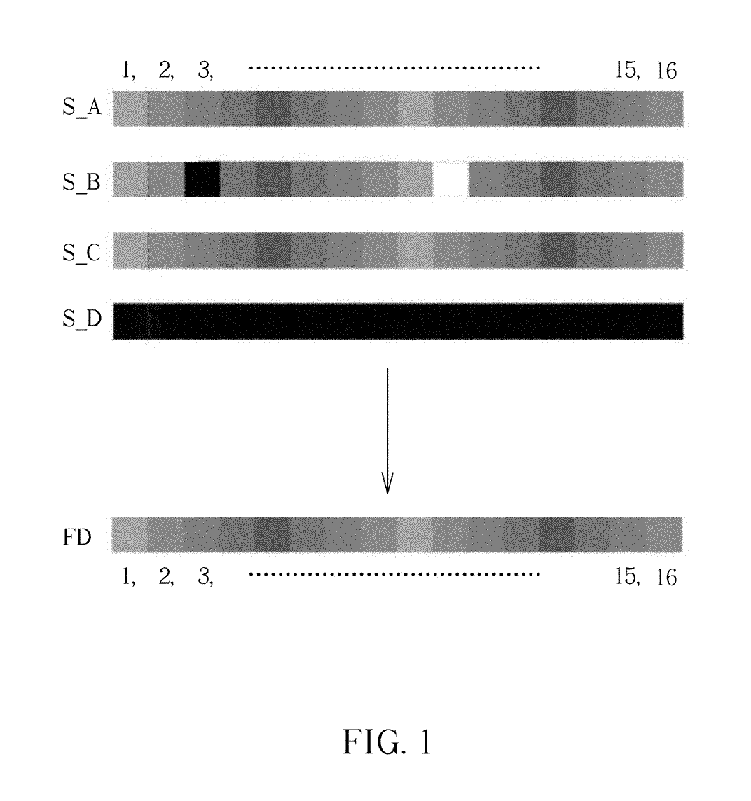

Please refer to FIG. 1, which is a schematic diagram of averaging a plurality of sensing data to reduce or eliminate the error of image data. As shown in FIG. 1, a row of sensing data in four sensing images received in four scan cycles S_A-S_D are considered, where each row of sensing data includes 16 sensing data, and the data codes of the sensing data are respectively denoted by A1-A16, B1-B16, C1-C16 and D1-D16. The data codes of the final data FD1-FD16 are generated by averaging corresponding sensing data in the scan cycles S_A-S_D, and may be calculated as follows:

$$FD 1 = ( A 1 + B 1 + C 1 + D 1 ) \text{/} 4 ;$$

$$FD 2 = ( A 2 + B 2 + C 2 + D 2 ) \text{/} 4 ;$$

$$FD 3 = ( A 3 + B 3 + C 3 + D 3 ) \text{/} 4 ;$$

$$……$$

$$FD 16 = ( A 16 + B 16 + C 16 + D 16 ) \text{/} 4.$$

However, the power noise from a power adapter may cause that the sensing image approaches to a white image or a black image. Correspondingly, the code value of the sensing data may approach to the minimum code or the maximum code. The minimum code or the maximum code may still generate a significant error in the final data after the averaging operation.

The present invention provides a method of filtering out those sensing data interfered with by the power noise and approaching to the minimum code or the maximum code before the averaging operation. Taking FIG. 1 as an example, the image sensing operation in the scan cycle S_D may be interfered with by the power noise; hence, the corresponding sensing data D1-D16 should be filtered out before the averaging operation.

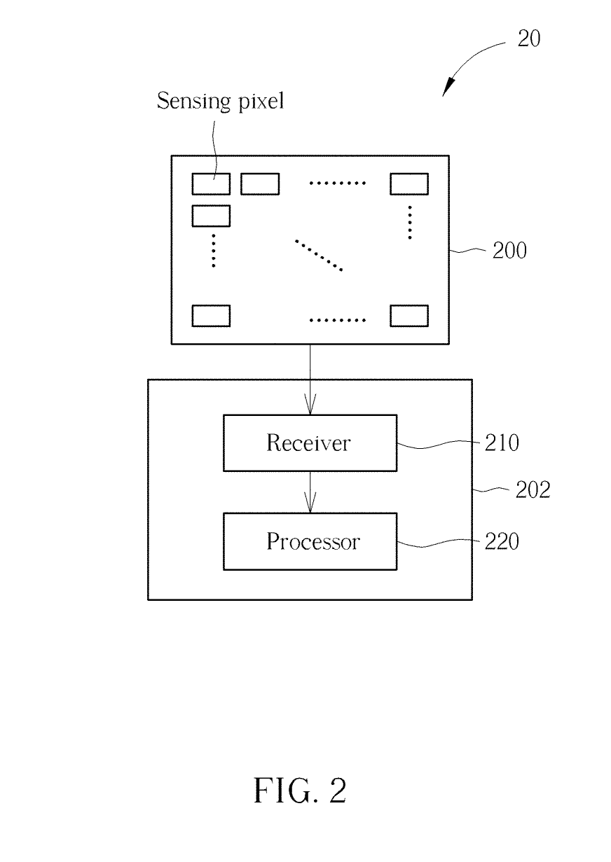

Please refer to FIG. 2, which is a schematic diagram of an image sensing system 20 according to an embodiment of the present invention. As shown in FIG. 2, the image sensing system 20 includes an image sensor 200 and an image sensing circuit 202. The image sensor 200 may be an in-cell or out-cell sensor implemented as a touch panel or a touch screen, for performing image sensing operations (e.g., fingerprint sensing operations) to generate a plurality of sensing signals. The image sensor 200 may include a plurality of sensing electrodes, considered as a plurality of sensing pixels, arranged in an array, where each sensing pixel may generate a sensing signal in a scan cycle. The image sensor 200 then outputs the sensing signals to the image sensing circuit 202. The image sensing circuit 202 may be an image sensing integrated circuit (IC) capable of processing the sensing signals to generate sensing results. For example, a sensing result may be recognition and determination of whether the sensing signals are generated from a fingerprint of a registered user.

In detail, the image sensing circuit 202 may include a receiver 210 and a processor 220. The receiver 210 may be an analog front-end circuit for receiving the sensing signals from the image sensor 200. The receiver 210 may include a plurality of ADCs for converting the sensing signals into a plurality of digital sensing data. The processor 220 then processes the sensing data to obtain the sensing results. The processor 220 may be a central processing unit (CPU), a controller, a microcontroller unit (MCU), or any other processing unit that is capable of processing the sensing data.

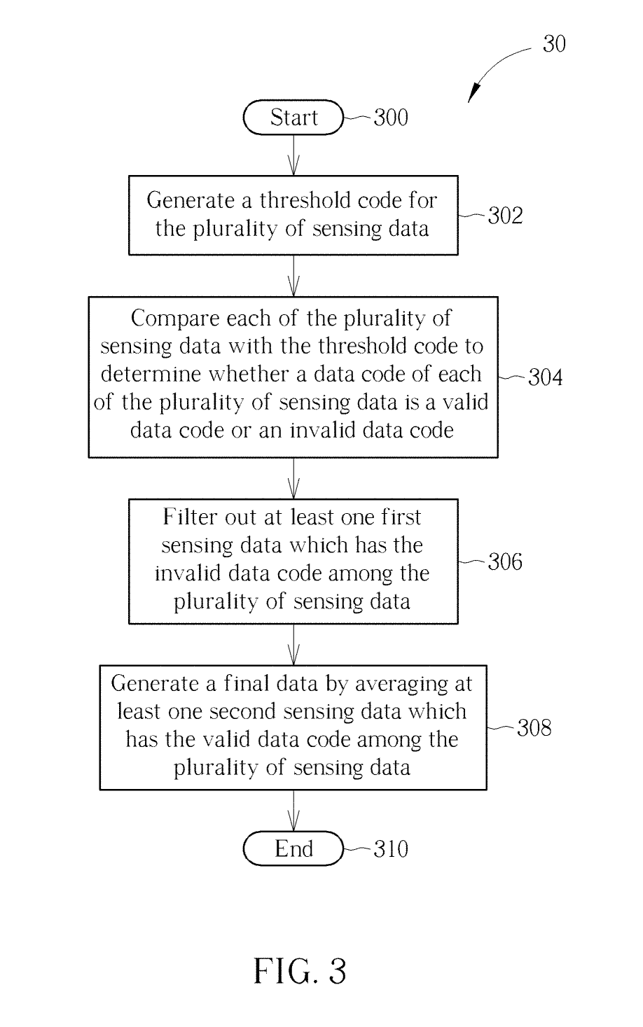

Please refer to FIG. 3, which is a flow chart of a process 30 according to an embodiment of the present invention. The process 30 may be implemented in the processor 220, which receives a plurality of sensing data from the receiver 210. As shown in FIG. 3, the process 30 includes the following steps:

Step 300: Start.

Step 302: Generate a threshold code for the plurality of sensing data.

Step 304: Compare each of the plurality of sensing data with the threshold code to determine whether a data code of each of the plurality of sensing data is a valid data code or an invalid data code.

Step 306: Filter out at least one first sensing data which has the invalid data code among the plurality of sensing data.

Step 308: Generate a final data by averaging at least one second sensing data which has the valid data code among the plurality of sensing data.

Step 310: End.

According to the process 30, a threshold code is generated for the sensing data. The data code of each of the sensing data is compared with the threshold code, to determine whether the data code is a valid data code or an invalid data code. A sensing data may be filtered out if the sensing data has the invalid data code, i.e., the data code of the sensing data is the invalid data code. The rest sensing data, which have the valid data code, are averaged to generate the final data. In other words, the final data is calculated based on only the sensing data having the valid data code, where the sensing data having the invalid data code may be excluded.

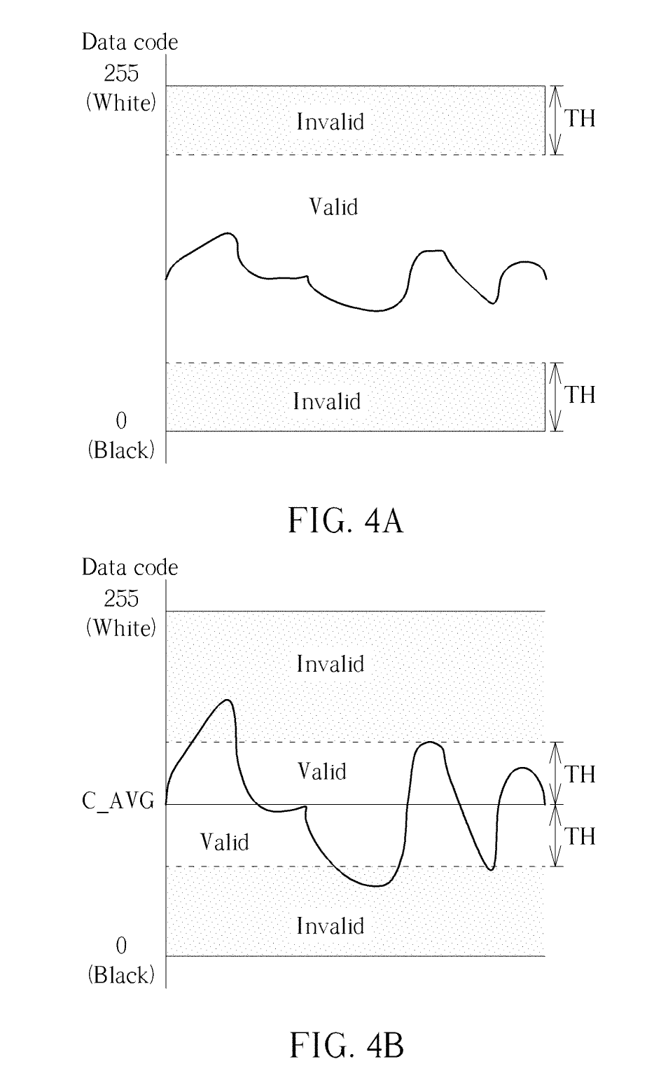

Please refer to FIG. 4A, which is a schematic diagram of determining the validity of data codes according to an embodiment of the present invention. FIG. 4A illustrates a distribution of data codes between a maximum code 255 and a minimum code 0, wherein the maximum code 255 stands for a white image detected in the corresponding pixel and the minimum code 0 stands for a black image detected in the corresponding pixel. The threshold code TH may be configured to any value that may define the range of valid data code and the range of invalid data code. In the embodiment shown in FIG. 4A, the data code of a sensing data is determined to be the invalid data code when the data code is within a range between the minimum code 0 and the minimum code 0 plus the threshold code TH or within a range between the maximum code 255 and the maximum code 255 minus the threshold code TH. The data code of a sensing data is determined to be the valid data code when the data code is within a range between the minimum code 0 plus the threshold code TH and the maximum code 255 minus the threshold code TH.

For example, the threshold code TH may be configured to be 30 in an embodiment. In such a situation, a sensing data may be determined to be an invalid data if its data code is between 0 and 30 (approaching to a black image) or between 225 and 255 (approaching to a white image), and the sensing data may be filtered out before the averaging operation. A sensing data may be determined to be a valid data if its data code is between 30 and 225, and the sensing data may be averaged with other valid sensing data to generate the final data.

As shown in FIG. 4A, the vertical axis illustrates the possible values of the data codes, and the horizontal axis illustrates the data codes of a plurality of sensing data that are determined to be valid or invalid and may be averaged to generate the final data if valid. The values of data codes of the plurality of sensing data are connected as a line graph. The plurality of sensing data are converted from a plurality of corresponding sensing signals which are generated from a sensing pixel of the image sensor 200 in a plurality of scan cycles of the image sensor 200. Preferably, the sensing data corresponding to the same sensing pixel generated in several consecutive scan cycles within a period of time are collected as a group to determine the validity and perform the average operation. If there are more sensing data included in the group, the fingerprint determination result may be more accurate.

It should be noted that the data codes range between 0 and 255, where there is a 256-value distribution of the data codes. Different code values may represent different capacitance sensed by a capacitive type fingerprint sensor, or may represent different light strength sensed by a light-sense fingerprint sensor. In general, the code values between the maximum code and the minimum code comply with a data range of the ADC generating the sensing data, e.g., the ADC in the receiver 210. For example, 256 values refer to 256 possible values of the output data of the ADC. In this embodiment, the ADC is an 8-bit ADC capable of outputting 2⁸=256 different values, which are denoted by 0-255 in FIG. 4A. In another embodiment, if another type of ADC is applied to receive the sensing signals, the number of possible values of data codes may change correspondingly.

Please note that the present invention aims at providing a method of handling the sensing data of fingerprint sensing. Those skilled in the art may make modifications and alternations accordingly. For example, the embodiments of the present invention are not only applicable to a fingerprint sensing system, but also applicable to any other type of image sensing system. In addition, the circuit structure shown in FIG. 2 is one of various embodiments of the present invention. In another embodiment, a part or entire of the image sensing circuit 202 may be integrated into a touch screen or touch panel including the image sensor 200. Further, the threshold code TH applied to determine the validity of data codes may be generated by another method.

Please refer to FIG. 4B, which is a schematic diagram of determining the validity of data codes according to another embodiment of the present invention. Similar to FIG. 4A, FIG. 4B also illustrates a distribution of data codes between a maximum code 255 and a minimum code 0, wherein the maximum code 255 stands for a white image detected in the corresponding pixel and the minimum code 0 stands for a black image detected in the corresponding pixel. The threshold code TH may be configured to any value that may define the range of valid data code and the range of invalid data code, but the definition of the threshold code TH in FIG. 4B is different from that shown in FIG. 4A. In the embodiment shown in FIG. 4B, an average code value C_AVG of the data codes of the sensing data is obtained before the determination of validity. If there are N sensing data collected as a group to determine the validity and perform the average operation, N data codes of the N sensing data are averaged to obtain the average code value C_AVG. Subsequently, the validity determination may be performed based on the average code value C_AVG and the threshold code TH. In detail, the data code of a sensing data is determined to be the invalid data code when the data code is within a range between the minimum code 0 and the average code value C_AVG minus the threshold code TH or within a range between a maximum code 255 and the average code value C_AVG plus the threshold code TH. The data code of a sensing data is determined to be the valid data code when the data code is within a range between the average code value C_AVG minus the threshold code TH and the average code value C_AVG plus the threshold code TH.

Similar to those shown in FIG. 4A, in FIG. 4B the vertical axis illustrates the possible values of the data codes, and the horizontal axis illustrates the data codes of a plurality of sensing data that are determined to be valid or invalid and may be averaged to generate the final data. As shown in FIG. 4B, the range of data codes is a 256-value distribution from 0 to 255.

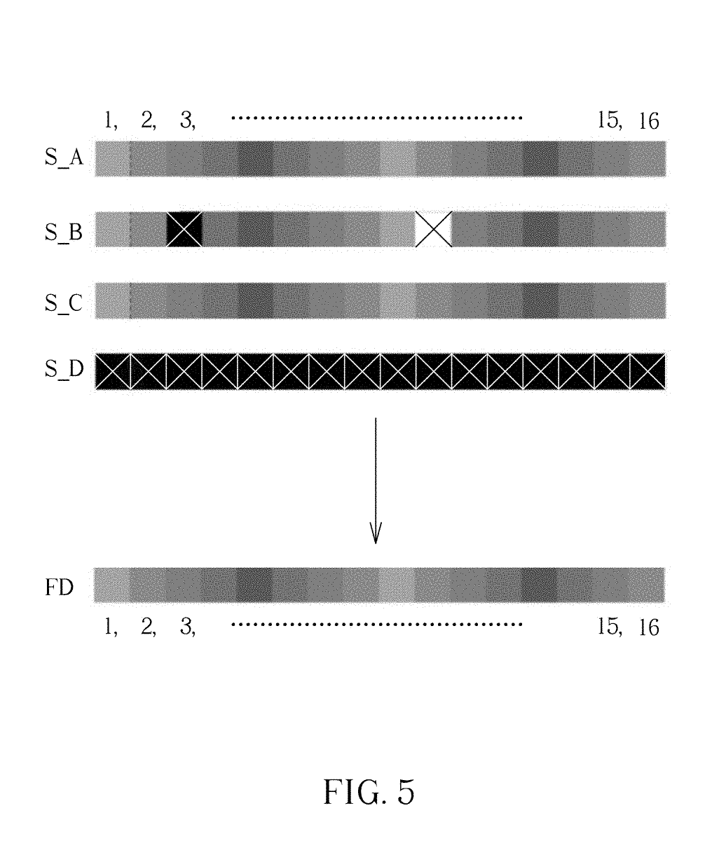

As mentioned in FIG. 1 and the above related paragraphs, all sensing data corresponding to the sensing images received in the scan cycles S_A-S_D are applied to perform the average operation to generate the final data, no matter whether the sensing data are interfered with by power noise. According to the method of the present invention, several sensing data which are determined to have invalid data codes are filtered out before the averaging operation generating the final data. An exemplary embodiment similar to the case in FIG. 1 is illustrated in FIG. 5, where the sensing data corresponding to a nearly white or black image are filtered out or eliminated, which are marked with a crisscross. Subsequently, the calculation method of the final data FD1-FD16 may be modified as follows:

$$FD 1 = ( A 1 + B 1 + C 1 ) \text{/} 3 ;$$

$$FD 2 = ( A 2 + B 2 + C 2 ) \text{/} 3 ;$$

$$FD 3 = ( A 3 + C 3 ) \text{/} 2 ;$$

$$FD 4 = ( A 4 + B 4 + C 4 ) \text{/} 3 ;$$

$$……$$

$$FD 9 = ( A 9 + B 9 + C 9 ) \text{/} 3 ;$$

$$FD 10 = ( A 10 + C 10 ) \text{/} 2 ;$$

$$FD 11 = ( A 11 + B 11 + C 11 ) \text{/} 3 ;$$

$$……$$

$$FD 16 = ( A 16 + B 16 + C 16 ) \text{/} 3.$$

Table 1 illustrates an exemplary embodiment of determining the validity of the data codes and generating the final data by averaging the valid data codes according to the present invention. The validity determination of the data codes is performed based on the criteria shown in FIG. 4A with the threshold code equal to 20; that is, the data codes 0-20 and 235-255 are determined to be invalid. In Table 1, the invalid data codes are marked with a strikethrough (e.g., the data codes B1-B16, D1-D5 and D10-D16), and the final data FD1-FD16 are obtained by averaging the valid data only.

TABLE 1

| No. | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|
| | TH = 20 | | | | | | | | | | | | | | | |
| A | 198 | 196 | 190 | 187 | 177 | 100 | 95 | 108 | 92 | 173 | 175 | 182 | 95 | 115 | 109 | 99 |
| B | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| C | 188 | 187 | 180 | 178 | 169 | 95 | 115 | 109 | 99 | 162 | 166 | 175 | 90 | 105 | 99 | 101 |
| D | [symbol] | [symbol] | [symbol] | [symbol] | [symbol] | 90 | 105 | 99 | 101 | [symbol] | [symbol] | [symbol] | [symbol] | [symbol] | [symbol] | [symbol] |
| | Final Data (FD) | | | | | | | | | | | | | | | |
| FD | 193 | 192 | 185 | 183 | 173 | 95 | 105 | 105 | 97 | 168 | 171 | 179 | 93 | 110 | 104 | 100 |

As mentioned above, the threshold code may be configured to any value that may define the range of valid data code and the range of invalid data code. The threshold code may be configured for filtering out the data codes corresponding to a nearly white or black image. The threshold code may be a fixed value and predetermined before the image sensing circuit 202 is integrated into the electronic product. For example, the IC provider may perform a test for an image sensing IC implemented with a corresponding touch panel of a mobile phone to find out the optimal value of the threshold code, and then configure the threshold code to its optimal value. Alternatively, the threshold code may be adjustable. For example, the threshold code may be adjusted in the engineering mode of the mobile phone, and/or may be adjusted based on environmental situations faced by the electronic product with the usage of fingerprint sensing function.

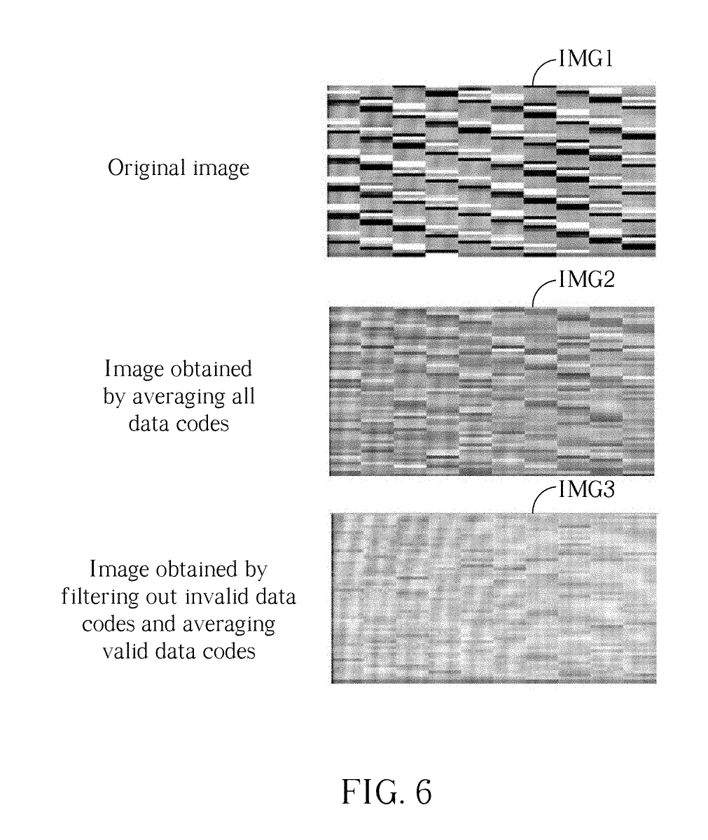

Please note that the method of filtering out invalid data codes before averaging the data codes according to embodiments of the present invention significantly enhances the performance of fingerprint sensing. Please refer to FIG. 6, which is a schematic diagram of comparison of different fingerprint images obtained by different methods. The image IMG1 is one original image received by the image sensing circuit without digital data processing such as an averaging operation. The image IMG2 is obtained from the final data which is generated by averaging all data codes obtained in specific scan cycles, as the method shown in FIG. 1. The image IMG3 is obtained from the final data which is generated by filtering out the invalid data codes and averaging the valid data codes according to embodiments of the present invention. The comparison of these images shows that the quality of the image IMG3 is much better than the quality of the images IMG1 and IMG2. Note that a fingerprint image is recognizable in the image IMG3 but unrecognizable in the images IMG1 and IMG2.

To sum up, the present invention provides a method of handling image sensing data and a related image sensing circuit for fingerprint sensing. Several sensing data may be averaged to obtain a final data for determination of the fingerprint. Since the image sensing operation may be interfered with by power noise, a filtering scheme is applied to the sensing data to be averaged. According to a threshold code, the data codes of the sensing data may be determined to be valid or invalid. The valid data codes are averaged to obtain the final data, where the invalid data codes are filtered out and excluded in the averaging operation. Thus, the sensing data having invalid data codes, which may generate a significant error in the final data, are filtered out, so that the accuracy of the final data and the quality of the fingerprint image obtained from the final data may be enhanced, which in turn enhances the fingerprint sensing performance of the image sensing circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling a plurality of sensing data, the method comprising:
generating a threshold code for the plurality of sensing data;
comparing each of the plurality of sensing data with the threshold code to determine whether a data code of each of the plurality of sensing data is a valid data code or an invalid data code;
filtering out at least one first sensing data which has the invalid data code among the plurality of sensing data; and
generating a final data by averaging at least one second sensing data which has the valid data code among the plurality of sensing data.

2. The method of claim 1, wherein the step of comparing each of the plurality of sensing data with the threshold code to determine whether the data code of each of the plurality of sensing data is the valid data code or the invalid data code comprises:
determining that the data code of one of the plurality of sensing data is the invalid data code when the data code is within a range between a minimum code and the minimum code plus the threshold code or within a range between a maximum code and the maximum code minus the threshold code.

3. The method of claim 1, wherein the step of comparing each of the plurality of sensing data with the threshold code to determine whether the data code of each of the plurality of sensing data is the valid data code or the invalid data code comprises:
determining that the data code of one of the plurality of sensing data is the valid data code when the data code is within a range between a minimum code plus the threshold code and a maximum code minus the threshold code.

4. The method of claim 1, further comprising:
calculating an average code value of the data codes of the plurality of sensing data.

5. The method of claim 4, wherein the step of comparing each of the plurality of sensing data with the threshold code to determine whether the data code of each of the plurality of sensing data is the valid data code or the invalid data code comprises:
determining that the data code of one of the plurality of sensing data is the invalid data code when the data code is within a range between a minimum code and the average code value minus the threshold code or within a range between a maximum code and the average code value plus the threshold code.

6. The method of claim 4, wherein the step of comparing each of the plurality of sensing data with the threshold code to determine whether the data code of each of the plurality of sensing data is the valid data code or the invalid data code comprises:
determining that the data code of one of the plurality of sensing data is the valid data code when the data code is within a range between the average code value minus the threshold code and the average code value plus the threshold code.

7. The method of claim 1, wherein the plurality of sensing data are converted from a plurality of sensing signals which are generated from a sensing pixel of the image sensor in a plurality of scan cycles of the image sensor.

8. The method of claim 1, wherein the threshold code is adjustable.

9. The method of claim 1, wherein code values between a maximum code and a minimum code of the data code comply with a data range of an analog to digital converter (ADC) generating the plurality of sensing data.

10. An image sensing circuit, comprising:
a receiver, for generating a plurality of sensing data according to a plurality of sensing signals from an image sensor; and
a processor, coupled to the receiver, for performing the following steps:
generating a threshold code for the plurality of sensing data;
comparing each of the plurality of sensing data with the threshold code to determine whether a data code of each of the plurality of sensing data is a valid data code or an invalid data code;
filtering out at least one first sensing data which has the invalid data code among the plurality of sensing data; and
generating a final data by averaging at least one second sensing data which has the valid data code among the plurality of sensing data.

11. The image sensing circuit of claim 10, wherein the step of comparing each of the plurality of sensing data with the threshold code to determine whether the data code of each of the plurality of sensing data is the valid data code or the invalid data code comprises:
determining that the data code of one of the plurality of sensing data is the invalid data code when the data code is within a range between a minimum code and the minimum code plus the threshold code or within a range between a maximum code and the maximum code minus the threshold code.

12. The image sensing circuit of claim 10, wherein the step of comparing each of the plurality of sensing data with the threshold code to determine whether the data code of each of the plurality of sensing data is the valid data code or the invalid data code comprises:
determining that the data code of one of the plurality of sensing data is the valid data code when the data code is within a range between a minimum code plus the threshold code and a maximum code minus the threshold code.

13. The image sensing circuit of claim 10, wherein the processor is further configured to perform the following step:
calculating an average code value of the data codes of the plurality of sensing data.

14. The image sensing circuit of claim 13, wherein the step of comparing each of the plurality of sensing data with the threshold code to determine whether the data code of each of the plurality of sensing data is the valid data code or the invalid data code comprises:
determining that the data code of one of the plurality of sensing data is the invalid data code when the data code is within a range between a minimum code and the average code value minus the threshold code or within a range between a maximum code and the average code value plus the threshold code.

15. The image sensing circuit of claim 13, wherein the step of comparing each of the plurality of sensing data with the threshold code to determine whether the data code of each of the plurality of sensing data is the valid data code or the invalid data code comprises:
determining that the data code of one of the plurality of sensing data is the valid data code when the data code is within a range between the average code value minus the threshold code and the average code value plus the threshold code.

16. The image sensing circuit of claim 10, wherein the plurality of sensing data are converted from the plurality of sensing signals which are generated from a sensing pixel of the image sensor in a plurality of scan cycles of the image sensor.

17. The image sensing circuit of claim 10, wherein the threshold code is adjustable.

18. The image sensing circuit of claim 10, wherein code values between a maximum code and a minimum code of the data code comply with a data range of an analog to digital converter (ADC) in the receiver.
